(19) United States
(12) Patent Application Publication
(10) Pub. No.: US 2012/0317153 A1
(43) Pub. Date: Dec. 13, 2012

(54) CACHING RESPONSES FOR SCOPED AND NON-SCOPED DOMAIN NAME SYSTEM QUERIES

(75) Inventors: Mohan Parthasarathy, Cupertino, CA (US); Joshua V. Graessley, San Jose, CA (US)

(73) Assignee: APPLE INC., Cupertino, CA (US)

(21) Appl. No.: 13/155,271

(22) Filed: Jun. 7, 2011

(51) Int. Cl. G06F 17/30

(52) U.S. Cl. 707/805; 707/E17.03

(57) ABSTRACT

In the described embodiments, while executing a DNS resolver, a processing subsystem in an electronic device with a set of network interfaces receives a scoped request from an application to determine an IP address for a domain name. Generally, a DNS query generated from a scoped request is to be transmitted only on network interfaces specified in the scoped request, whereas a DNS query generated from a non-scoped request can be transmitted on any of the network interfaces. The processing subsystem then generates a DNS query from the scoped request and transmits the DNS query on the specified network interfaces. Upon receiving a response to the DNS query, the processing subsystem stores a record of the response in a scoped portion of a DNS resolution cache that is used only for storing responses to scoped requests. The DNS resolution cache also comprises a non-scoped portion that is used only for storing responses to non-scoped requests.

### BACKGROUND

1. Field

The described embodiments relate to electronic devices. More specifically, the described embodiments relate to caching responses for scoped and non-scoped domain name system (DNS) queries in an electronic device.

2. Related Art

Many modern electronic devices support applications such as web browsers and email applications that use the domain name system (DNS) to determine intern& protocol (IP) addresses for domain names. To use the DNS, an application sends a request for an IP address for a domain name to a DNS resolver (which is another application running on the electronic device). Upon receiving the request from the application, the DNS resolver generates a DNS query that includes the domain name and forwards the DNS query to an operating system. The operating system uses network interfaces on the electronic device to transmit the DNS query to a DNS server to request the IP address associated with the domain name. When a response is received from the DNS server, the operating system sends the response to the DNS resolver, and the DNS resolver forwards the response to the requesting application. The application can then use the IP address in the response to communicate with the entity that uses the domain name. The DNS resolver can also cache the response to enable subsequent requests to be satisfied using the cached response, thereby avoiding sending multiple DNS queries for the same domain name.

Many electronic devices also support two or more network interfaces. For example, it is common for electronic devices such as smart phones and tablet computers to include interfaces for a cellular network and a Wi-Fi network. A problem can arise in such devices when a DNS query sent using two or more interfaces returns a different IP address on each of the interfaces, or when one interface does not return a response, but the other interfaces do. This can occur when a service provider or network administrator configures certain services (e.g., media browsing, voicemail, email with and without attachments, etc.) to be accessible only on a particular network (e.g., Wi-Fi and not the cellular network). The can also occur when a DNS server on a network provides a different DNS resolution then a different DNS server another network, such as when a user is connected through one interface to an internal corporate network and through another interface to the Internet. In such cases, the electronic device can cache the response and subsequently provide an incorrect IP address to an application using the cached response.

### SUMMARY

The described embodiments perform domain name resolution in an electronic device with a plurality of network interfaces. In the described embodiments, while executing a DNS resolver, a processing subsystem receives a scoped request from an application to determine an IP address for a domain name. Generally, a scoped request comprises an indication that a DNS query generated by the processing subsystem from the scoped request is to transmitted only on the network interfaces specified in the scoped request, whereas a non-scoped request comprises an indication that a DNS query generated by the processing subsystem from the non-scoped request can be transmitted on any of the network interfaces. The processing subsystem then generates a DNS query based on the scoped request and transmits the DNS query only on the network interfaces specified in the scoped request. Upon receiving a response to the DNS query, the processing subsystem forwards the response to the application and stores a record of the response in a scoped portion of a DNS resolution cache that is used only for storing responses to scoped requests. In the described embodiments, the DNS resolution cache also comprises a non-scoped portion that is used only for storing responses to non-scoped requests.

In some embodiments, the processing subsystem receives a subsequent scoped request to determine an IP address for a domain name from an application. The processing subsystem then checks a set of recorded responses in the scoped portion of the DNS resolution cache to determine if a stored response can be used to satisfy the subsequent scoped request. If so, the processing subsystem uses the stored response to satisfy the subsequent scoped request. Otherwise, the processing subsystem generates a DNS query based on the subsequent scoped request and transmits the DNS query only on the network interfaces specified in the scoped request. Upon receiving a response to the DNS query, the processing subsystem forwards the response to the application that sent the subsequent scoped request and stores a record of the response in the scoped portion of a DNS resolution cache.

In some embodiments, the processing subsystem receives a non-scoped request to determine an IP address for a domain name from an application. The processing subsystem then generates a DNS query based on the non-scoped request and transmits the DNS query on any of the available network interfaces. Upon receiving a response to the DNS query, the processing subsystem forwards the response to the application and stores a record of the response in the non-scoped portion of the DNS resolution cache that is used only for storing responses to non-scoped requests.

In some embodiments, the processing subsystem receives a subsequent non-scoped request to determine an IP address for a domain name from an application. The processing subsystem then checks a set of recorded responses in the non-scoped portion of the DNS resolution cache to determine if a stored response can be used to satisfy the subsequent non-scoped request. If so, the processing subsystem uses the stored response to satisfy the subsequent non-scoped request. Otherwise, the processing subsystem generates a DNS query based on the subsequent non-scoped request and transmits the DNS query on any of the available network interfaces. Upon receiving a response to the DNS query, the processing subsystem forwards the response to the application that sent the subsequent non-scoped request and stores a record of the response in the non-scoped portion of a DNS resolution cache.

In some embodiments, when receiving the scoped request, the processing subsystem receives a call to a function in an application programming interface (API) for the DNS resolver, wherein the call to the function comprises an argument that specifies the network interfaces upon which the DNS query is to be transmitted.

In some embodiments, the processing subsystem stores a record of the scoped request. In these embodiments, the record comprises information to identify the application that made the request and to determine that the request was scoped. Upon receiving the response to the DNS query, the processing subsystem uses the information in the record of the scoped request to determine the application that sent the request and to determine that the request was scoped. The processing subsystem then performs the forwarding and storing operations based on the determination.

In some embodiments, storing a record of the response in a scoped portion of a DNS resolution cache comprises storing a record that indicates: the domain name; the IP address; the network interfaces specified in the scoped request; and a DNS server that responded to the request.

### BRIEF DESCRIPTION OF THE FIGURES

FIG. 1 presents a block diagram of an electronic device in accordance with the described embodiments.

FIG. 2 presents a block diagram of an electronic device in a network environment in accordance with the described embodiments.

FIG. 3 presents a block diagram of an operating system in accordance with the described embodiments.

FIG. 4 presents a block diagram of an exemplary networking subsystem with a set of interfaces in accordance with the described embodiments.

FIG. 5 presents a block diagram of a DNS resolver in accordance with the described embodiments.

FIG. 6 presents a block diagram of a DNS resolution cache in accordance with the described embodiments.

FIG. 7 presents a block diagram of a scoped portion and a non-scoped portion in a DNS resolution cache with accordance with the described embodiments.

FIG. 8 presents a flowchart illustrating a process for performing a non-scoped IP address resolution for a domain name in accordance with the described embodiments.

FIG. 9 presents a flowchart illustrating a process for performing a scoped IP address resolution for a domain name in accordance with the described embodiments.

In the figures, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by an electronic device with computing capabilities. The computer-readable storage medium includes, but is not limited to, volatile memory and non-volatile memory, such as magnetic and optical storage devices such as disk drives, magnetic tape, CDs (compact discs), DVDs (digital versatile discs or digital video discs), or other media capable of storing data structures or code. Note that the computer-readable storage medium in the described embodiments is not intended to include non-statutory subject matter, such as transitory signals.

The methods and processes described in this detailed description can be included in hardware modules. For example, the hardware modules can include, but are not limited to, application-specific integrated circuit (ASIC) chips, field-programmable gate arrays (FPGAs), and other programmable-logic devices. When the hardware modules are activated, the hardware modules perform the methods and processes included within the hardware modules. In some embodiments, the hardware modules include one or more general-purpose circuits that are configured by executing instructions to perform the methods and processes.

The methods and processes described in the detailed description section can be embodied as code and/or data, which can be stored in a computer-readable storage medium as described above. When an electronic device with computing capabilities reads and executes the code and/or data stored on the computer-readable storage medium, the electronic device performs the methods and processes embodied as data structures and code and stored within the computer-readable storage medium.

In the following description, we refer to “some embodiments.” Note that “some embodiments” describes a subgroup of all of the possible embodiments, but does not always specify the same subset of the embodiments.

### Overview

The described embodiments include a DNS resolver in an electronic device that receives requests from applications to provide an IP address for a given domain name (e.g., provide an IP address such as “10.21.61.234” for a domain name such as “www.domain.com” or “mail.organization.net”). Upon receiving such a request, the DNS resolver determines if the request indicates that the request is to be sent only from specified interfaces from among a set of network interfaces in the electronic device, and is therefore scoped, or if the request is non-scoped, and can therefore be sent from any available network interface in the electronic device. Based on the determination, the DNS resolver generates a DNS query that is forwarded to an operating system in the device to be processed through a network stack and transmitted using the specified interfaces for a scoped request, or using any of the available interfaces for a non-scoped request.

When a response is returned for the DNS query, the DNS resolver returns the response to the requesting application. The DNS resolver also stores a copy of the response in a DNS resolution cache. In the described embodiments, the DNS resolution cache includes at least a scoped portion and a non-scoped portion. When caching the response, the DNS resolver stores the copy of the response in the scoped portion of the DNS resolution cache if the requesting application made a scoped request. Otherwise, if the requesting application made a non-scoped request, the DNS resolver stores the copy of the response in the non-scoped portion of the DNS resolution cache.

Upon subsequently receiving a scoped request from an application to provide an IP address for a domain name, the DNS resolver determines if a response for the domain name has been cached in the scoped portion of the DNS resolution cache. If so, the DNS resolver satisfies the request from the cached copy in the scoped portion of the DNS resolution cache. Otherwise, the DNS resolver generates a DNS query that is forwarded to an operating system in the device to be processed through the network stack and transmitted using the specified interfaces.

Upon subsequently receiving a non-scoped request from an application to provide an IP address for a domain name, the DNS resolver determines if the response has been cached in the non-scoped portion of the DNS resolution cache. If so, the DNS resolver satisfies the request from the cached copy in the non-scoped portion of the DNS resolution cache. Otherwise, the DNS resolver generates a DNS query that is forwarded to an operating system in the device to be processed through the network stack and transmitted using any of the available interfaces.

Note that non-scoped requests are not satisfied from the scoped portion of the DNS resolution cache, nor are scoped requests satisfied from the non-scoped portion. Thus, the described embodiments use a separate portion of the DNS resolution cache to satisfy requests for IP addresses based on the scoped or non-scoped nature of the request from the application. The following sections describe the mechanisms and operations in the described embodiments in more detail.

### Electronic Device

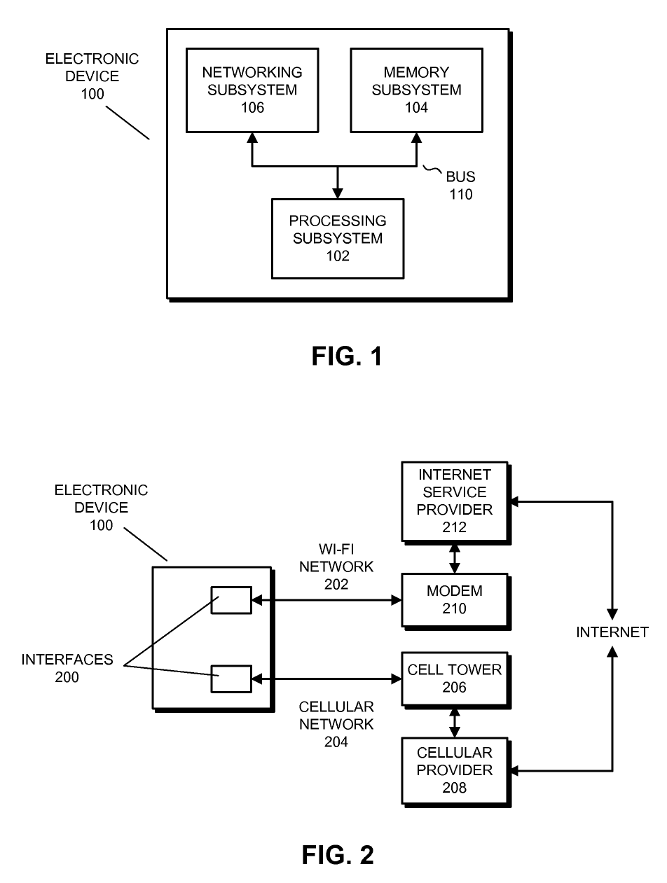

FIG. 1 presents a block diagram of electronic device 100 in accordance with the described embodiments. Electronic device 100 includes processing subsystem 102, memory subsystem 104, and networking subsystem 106.

Processing subsystem 102 includes one or more devices configured to perform computational operations. For example, processing subsystem 102 can include one or more microprocessors, application-specific integrated circuits (ASICs), microcontrollers, and/or programmable-logic devices.

Memory subsystem 104 includes one or more devices for storing data and/or instructions for processing subsystem 102 and networking subsystem 106. For example, memory subsystem 104 can include dynamic random access memory (DRAM), static random access memory (SRAM), and/or other types of memory. In addition, memory subsystem 104 can include mechanisms for controlling access to the memory. In some embodiments, memory subsystem 104 includes a memory hierarchy that comprises one or more caches coupled to a memory in electronic device 100. In some of these embodiments, one or more of the caches is located in processing subsystem 102.

In some embodiments, memory subsystem 104 is coupled to one or more high-capacity mass-storage devices (not shown). For example, memory subsystem 104 can be coupled to a magnetic or optical drive, a solid-state drive, or another type of mass-storage device. In these embodiments, memory subsystem 104 can be used by electronic device 100 as fast-access storage for often-used data, while the mass-storage device is used to store less frequently used data.

Networking subsystem 106 includes one or more devices configured to couple to and communicate on a wired and/or wireless network (i.e., to perform network operations). For example, networking subsystem 106 can include a Bluetooth™ networking system, a cellular networking system (e.g., a 3G/4G network), a universal serial bus (USB) networking system, a Wi-Fi networking system, a networking system based on the standards described in Institute for Electrical and Electronic Engineers (IEEE) 802.11, an Ethernet networking system, and/or another networking system. Networking subsystem 106 includes processors, controllers, radios/antennas, sockets/plugs, and/or other devices used for coupling to, communicating on, and handling data and events for each supported networking system.

In the following description, we refer to the mechanisms used for coupling to, communicating on, and handling data and events on the network for each network system collectively as the “interface” or “network interface” for the network system (some exemplary interfaces are shown in FIGS. 2 and 4).

Within electronic device 100, processing subsystem 102, memory subsystem 104, and networking subsystem 106 are coupled together using bus 110. Bus 110 is an electrical connection that the subsystems can use to communicate commands and data among one another. Although only one bus 110 is shown for clarity, different embodiments can include a different number or configuration of electrical connections between the subsystems.

Although shown as separate subsystems in FIG. 1, in some embodiments, some or all of a given subsystem can be integrated into one or more of the other subsystems in electronic device 100. Although alternative embodiments can be configured in this way, for clarity we describe the subsystems separately.

Electronic device 100 can be (or can be included in) any device with at least one network interface. For example, electronic device 100 can be (or can be included in) a desktop computer, a laptop computer, a server, a media player, an appliance, a subnotebook/netbook, a tablet computer, a cellular phone, a piece of testing equipment, a network appliance, a set-top box, a personal digital assistant (PDA), a smart phone, a toy, a controller, or another device.

Although we use specific components to describe electronic device 100, in alternative embodiments, different components and/or subsystems may be present in electronic device 100. For example, electronic device 100 may include one or more additional processing subsystems 102, memory subsystems 104, and/or networking subsystems 106. Alternatively, one or more of the subsystems may not be present in electronic device 100.

In some embodiments, electronic device 100 may include one or more additional subsystems that are not shown in FIG. 1. For example, electronic device 100 can include, but is not limited to, a display subsystem for displaying information on a display, a data collection subsystem, an audio and/or video subsystem, an alarm subsystem, a media processing subsystem, and/or an input/output (I/O) subsystem.

FIG. 2 presents a block diagram illustrating electronic device 100 in a network environment in accordance with the described embodiments. As can be seen in FIG. 2, electronic device 100 is coupled to a Wi-Fi network 202 and a cellular network 204 through corresponding interfaces 200 in electronic device 100. Wi-Fi network 202 couples though modem 210 to internet service provider 212, which provides access to the Internet to electronic device 100. Cellular network 204 couples through cell tower 206 to cellular provider 208, which also provides access to the Internet to electronic device 100.

Although we describe the network environment shown in FIG. 2 as an example, in alternative embodiments, electronic device 100 can include other interfaces and/or connect to other networks. For example, electronic device 100 can couple to a wireless network, an Ethernet network, or any other type of network using an appropriate interface in electronic device 100. Generally, in the described embodiments, electronic device 100 can couple to any type of network or combinations of networks upon which scoped DNS queries can be transmitted.

### Operating System

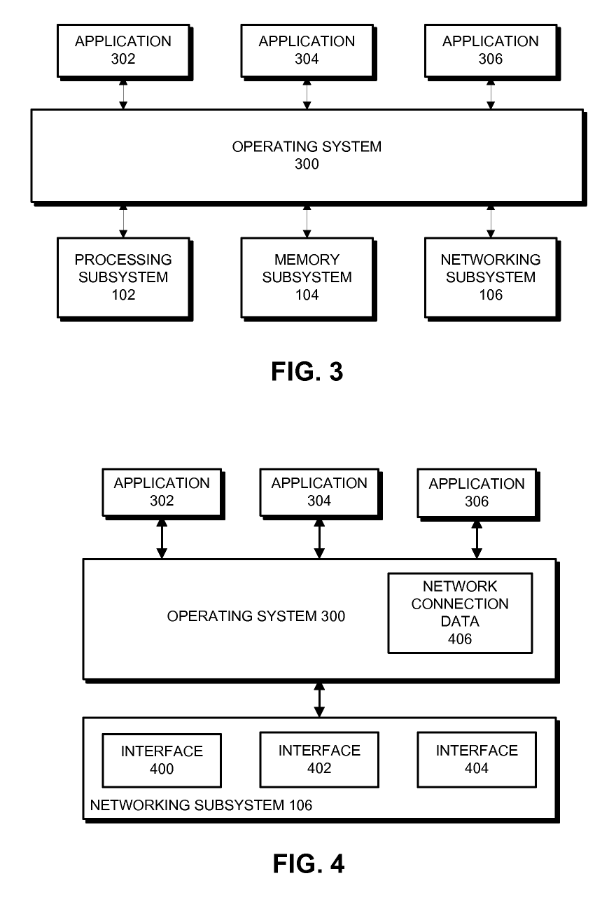

FIG. 3 presents a block diagram of an operating system 300 executed by processing subsystem 102 in accordance with the described embodiments. Generally, operating system 300 serves as an intermediary between system hardware in electronic device 100 (e.g., subsystems 102-106) and applications executed by processing subsystem 102, such as applications 302-306 (which can be, for example, an email application, a web browser, and a game application, respectively). For example, operating system 300 can be, but is not limited to being, the OS X operating system from Apple Inc. of Cupertino, Calif.; the FreeBSD operating system from The FreeBSD Foundation of Boulder, Colo.; or another operating system. Operating systems and their general functions are known in the art and hence are not described in detail.

To manage the transfer of packets to and from applications in electronic device 100 using an appropriate interface in networking subsystem 106, operating system 300 maintains one or more network protocol stacks (not shown) that each includes a number of logical layers. For example, the operating system can maintain an Internet protocol stack, which includes the link, Internet, transport, and application layers. As another example, the operating system can maintain a protocol stack based on the OSI model, which includes the application, presentation, session, transport, network, data-link, and physical layers. At each layer of the protocol stack, the operating system includes control mechanisms and data structures for performing the functions associated with the layer. The functions associated with each of the layers in the protocol stacks are known in the art and hence are not described in detail.

### Network Connection Data Maintained by the Operating System

In the described embodiments, operating system 300 includes network connection data 406 (see FIG. 4), which comprises records, information, and/or data for monitoring, configuring, and/or controlling the operation of the network systems in networking subsystem 106. For example, in some embodiments, operating system 300 includes interface data structures that are used to keep records for the network interfaces in networking subsystem 106 (e.g., Ethernet interfaces, cellular interfaces, Bluetooth™ interfaces, Wi-Fi interfaces, etc.). Operating system 300 can also include route data structures that are used to keep a record of route information to enable the operating system 300 to select an appropriate network interface for transmitting packets to a given destination. The records, information, and data in network connection data 406 are generally known in the art and hence are not described in detail.

FIG. 4 presents a block diagram illustrating an exemplary networking subsystem 106 with a set of interfaces in accordance with the described embodiments. As can be seen in FIG. 4, networking subsystem 106 includes interfaces 400-404, which can be, for example, a Bluetooth™ interface, an cellular interface, and a Wi-Fi wireless network interface, respectively. As described above, applications 302-306 can be, for example, an email application, a web browser, and a game application, respectively, that each use routes in operating system 300 and a corresponding interface 400-404 in networking subsystem 106 to transfer data packets to other entities.

### DNS Resolver

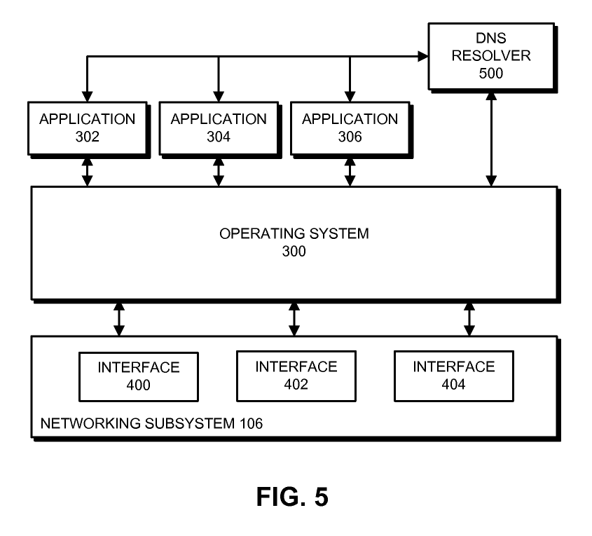

In the described embodiments, the applications executed by processing subsystem 102 include a DNS resolver. FIG. 5 presents a block diagram illustrating DNS resolver 500 in accordance with the described embodiments. DNS resolver 500 performs various DNS operations in electronic device 100. For example, the operations performed by DNS resolver 500 can include IP address resolution and responding to multicast DNS queries received by electronic device 100. Although numerous implementations of DNS resolver 500 can be used in the described embodiments, in some embodiments DNS resolver 500 is the mDNSResponder daemon from Apple Inc. of Cupertino, Calif.

In some embodiments, DNS resolver 500 comprises an application programming interface (API) with a number of different functions that can be called by applications 302-306 to invoke a corresponding function in DNS resolver 500. Using the example of the IP address resolution, DNS resolver 500 can provide a function call in the API that enables a calling application to specify that an IP address resolution is desired for a domain name that is passed as an argument of the function call. For example, the API for the above-described mDNSResponder includes several functions, such as the DNS ServiceQueryRecord and DNS ServiceGetAddedInfo to enable applications to interface with the mDNSResponder.

### Scoped and Non-Scoped DNS Queries

In the described embodiments, DNS resolver 500 includes mechanisms that enable a requesting application to specify the interfaces upon which a DNS query is to be sent during an IP address resolution. For example, an application can indicate that the DNS query is to be sent only on interface 400, on either of interfaces 400 and 404, etc. For clarity and convenience, we call requests for IP address resolution where the requesting application has specified that the request is to be transmitted using one or more of the interfaces “scoped” requests. In contrast to scoped requests, requesting applications can also send “non-scoped” requests which do not specify the interfaces on which the request is to be sent and hence indicate that the request can be sent on any of the available interfaces.

In some embodiments, the function call in the API that enables a calling application to specify that an IP address resolution is desired for a domain name also includes one or more arguments that enable a calling application to specify the interface or interfaces upon which a DNS query is to be sent. In these embodiments, the API call can indicate a specific “interface index.”

### DNS Resolution Cache

In the described embodiments, DNS resolver 500 caches responses received for DNS queries in a DNS resolution cache. FIG. 5 presents a block diagram illustrating a DNS resolution cache 600 in accordance with the described embodiments. In these embodiments, upon receiving a response to a DNS query from operating system 300, DNS resolver 500 forwards the IP address in the response to a requesting application, and stores (or “caches”) a copy of the response in an appropriate location in DNS resolution cache 600. The stored responses can then be retrieved from DNS resolution cache 600 and used to satisfy subsequent requests for IP address resolution for domain names from applications 302-306.

DNS resolution cache 600 comprises a set of entries (not shown), each of which can be used to store a record of a response. Generally, the entries comprise information for identifying and satisfying requests for IP addresses based on domain names. For example, the information in each entry can comprise the domain name, the IP address associated with the domain name, the interface that was used to send the corresponding DNS query, and other metadata (e.g., a valid indicator, control data, an identification of the DNS server that responded to the DNS query, etc.).

In the described embodiments, the entries in DNS resolution cache 600 comprise at least a scoped portion and a non-scoped portion. FIG. 7 presents a block diagram illustrating a scoped portion 700 and a non-scoped portion 702 in DNS resolution cache 600 in accordance with the described embodiments. Scoped portion 700 is used for storing records of the responses returned for DNS queries based on scoped requests, and non-scoped portion 702 is used for storing records of the responses returned for DNS queries based on non-scoped requests. Note that responses for scoped requests are not stored in non-scoped portion 702, nor are responses for non-scoped requests stored in scoped portion 700.

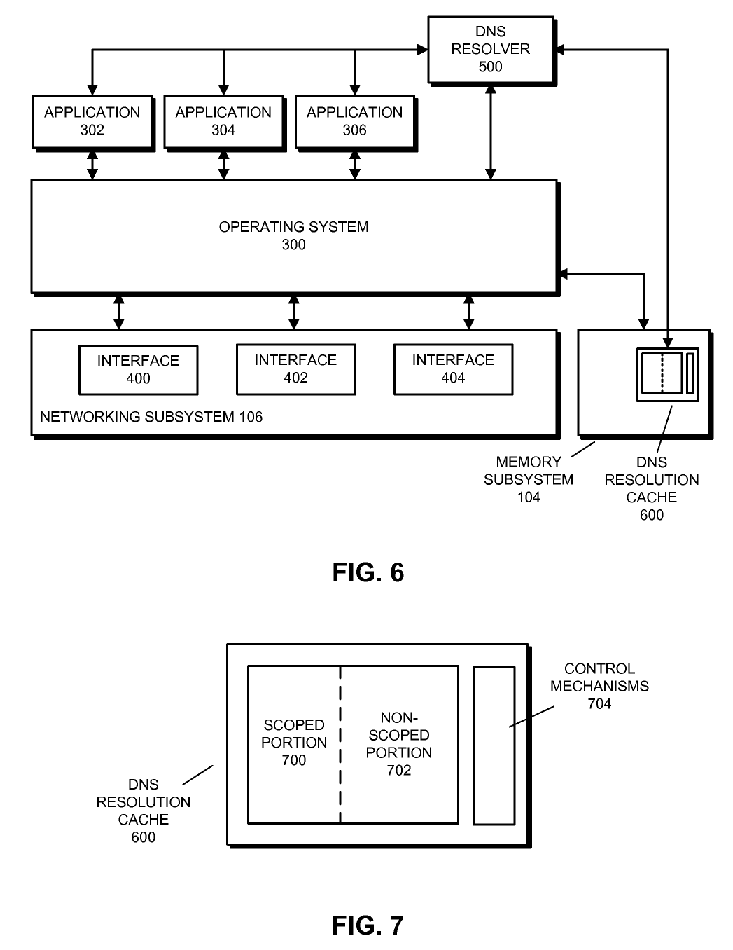

In some embodiments, the entries in DNS resolution cache 600 can be included in one or more of the caches and/or the memory in memory subsystem 104 (e.g., in the embodiment shown in FIG. 6). In alternative embodiments, the entries in DNS resolution cache 600 can be included in a dedicated memory in electronic device 100. In some embodiments, DNS resolution cache 600 comprises a contiguous block of memory in a cache or memory, but in other embodiments, DNS resolution cache 600 comprises one or more non-contiguous blocks of memory. In the described embodiments, DNS resolution cache 600 is initialized when electronic device 100 starts.

Generally, in distinguishing scoped portion 700 of DNS resolution cache 600 from non-scoped portion 702, the described embodiments can use any technique or mechanism that enables distinguishing the scoped portion of DNS resolution cache 600 from the non-scoped portion. For example, the described embodiments can use a separate block of memory for each portion of the cache, can use an indicator such as a pointer to divide a contiguous block of memory into the two portions, can use a set of pointers or references to memory locations (possibly intermixed) in one or more caches and/or the memory for each portion of DNS resolution cache 600, or can use another mechanism.

In some embodiments, the size and/or arrangement of DNS resolution cache 600 is not fixed. For example, in some embodiments, the sizes of scoped portion 700 and non-scoped portion 702 are not fixed and may be dynamically adjusted at runtime (the relative sizes of the portions in FIG. 7 are only illustrative). In these embodiments, when DNS resolution cache 600 requires more space for scoped records and/or non-scoped records, or on a predetermined interval, the portions of the cache can be resized, reorganized, garbage collected, etc. For example, a pointer that indicates a boundary between the scoped portion and the non-scoped portions can be adjusted to change the sizes of the portions, old records can be deleted, records can be removed to a second level cache, records can be reorganized, duplicates can be merged, DNS resolution cache 600 can be resized, etc. Techniques for dynamically organizing caches are generally known in the art and hence are not described in detail. Note that runtime can be any time after electronic device 100 starts up and/or after DNS resolution cache 600 is initialized, including when one or more records have been and/or are stored in DNS resolution cache 600.

In some embodiments, DNS resolution cache 600 comprises control mechanisms 704, which are mechanisms that control various aspects of the operation of DNS resolution cache 600. For example, these mechanisms can include one or more adjustment mechanisms that dynamically adjust at least one of a size or an arrangement of at least one of scoped portion 700, non-scoped portion 702, and DNS resolution cache 600 at runtime based on one or more runtime conditions (as is described above). These mechanisms can also include one or more lookup mechanisms that compare scoped or non-scoped requests with cached records of responses to scoped or non-scoped requests, respectively, to determine if the respective scoped or non-scoped requests can be satisfied from the cached records. In addition, these mechanisms can include a returning mechanism that returns recorded responses to scoped and non-scoped requests when the scoped and non-scoped requests can be satisfied from corresponding cached records.

Although we show control mechanisms 704 as part of DNS resolution cache 600, the operations performed by control mechanisms 704 can be performed by other subsystems in electronic device 100 (e.g., memory subsystem 104, networking subsystem 106 and/or processing subsystem 102), or the described mechanisms can be located in other subsystems in electronic device 100 or in other places in electronic device 100. In some embodiments, there are fewer or additional mechanisms (not shown) for performing the operations of the DNS resolution cache 600. Generally, each of the functions herein described as being performed by DNS resolution cache 600 can be performed by a hardware mechanism (e.g., a circuit, a functional block, etc.) in DNS resolution cache 600 or by another hardware mechanism in electronic device 100.

Note that the responses for DNS queries are separately cached for “scoped” and “non-scoped” requests (i.e., the entries in DNS resolution cache 600 includes “scoped” portion 700 and “non-scoped” portion 702). However, the described embodiments typically do not use the interface alone for caching because a DNS query may be transmitted on a first interface (e.g., interface 400) and a response may be returned on a second interface (e.g., interface 402). The entries in DNS resolution cache 600 each include an indication of the interface upon which the corresponding DNS query was transmitted that can be used to determine interface information for the cached response.

### Multiple Records for the Same Domain Name in the DNS Resolution Cache

In the described embodiments, one or more applications can make scoped requests for IP addresses for the same domain name on different interfaces. For example, application 304 can make a first scoped request for an IP address for the domain name “www.domain.com” on interface 400, and can then make a second scoped request for an IP address for the domain name on interface 402. In these cases, after the responses have been received from the corresponding DNS servers, scoped portion 700 includes two cached records for “www.domain.com.” To prevent the return of an erroneous value when an application subsequently makes a scoped request for “www.domain.com” on a given interface, the described embodiments can record the one or more interfaces upon which each request was transmitted in the corresponding entry in DNS resolution cache 600. Using the example above, these embodiments would have two records in DNS resolution cache 600, the first record indicating that the domain name “www.domain.com” resulted in IP address A on interface 400, and the second record indicating that the same domain name resulted in IP address B on interface 402 (in some cases, IP address A will match IP address B, but separate records will be maintained).

In addition, a given application (e.g., application 304) can have separately made both a scoped request for a domain name and a non-scoped request for the same domain name to DNS resolver 500. Thus, both scoped portion 700 and non-scoped portion 702 of DNS resolution cache 600 can hold a record that was returned in response to a request from the same application.

In the described embodiments, a given application is not considered as “scoped” or “not-scoped” (and hence responses from DNS queries initiated by the application may not always be stored in the same portion of DNS resolution cache 600) because applications can make either scoped or non-scoped requests at any time. The scoping (or not) of the DNS query is used to determine the portion of DNS resolution cache 600 in which the response is cached.

### Performing a Non-Scoped IP Address Resolution for a Domain Name

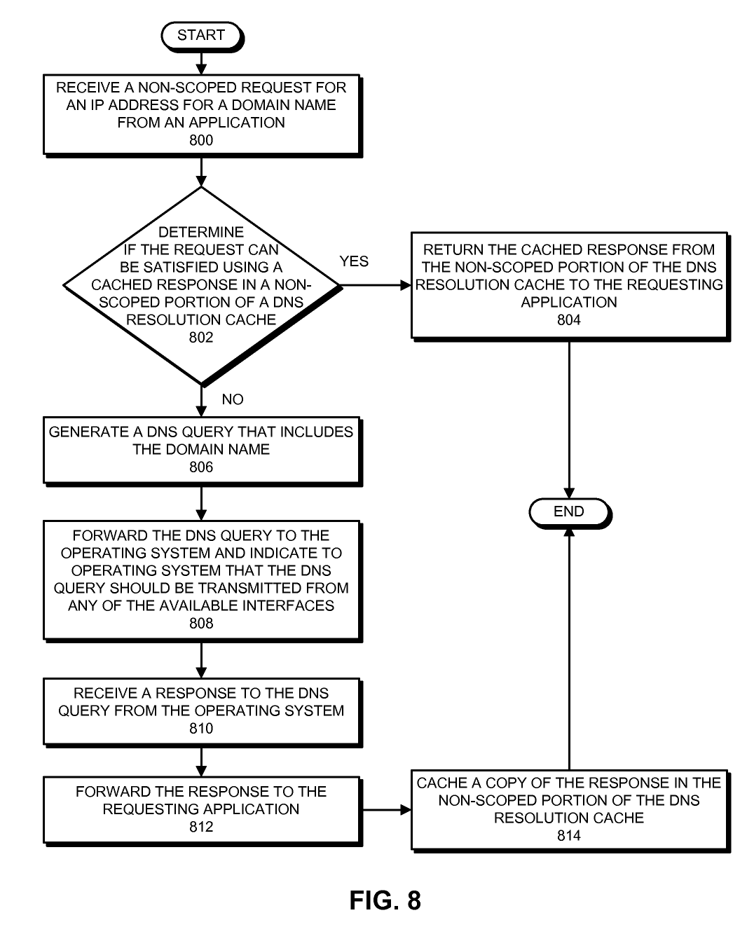

FIG. 8 presents a flowchart illustrating a process for performing a non-scoped IP address resolution for a domain name in accordance with the described embodiments. The process shown in FIG. 8 starts when DNS resolver 500 receives a non-scoped request for an IP address for a domain name from an application executing on electronic device 100 (e.g., one of applications 302-306) (step 800). For example, DNS resolver 500 can receive a request that indicates the domain name “mail.service.net.” Because the request is non-scoped, the request indicates that DNS resolver 500 should cause operating system 300 to transmit a corresponding DNS query on any of the available interfaces (e.g., any of interfaces 400-404).

DNS resolver 500 then determines if the request can be satisfied using a cached response from non-scoped portion 702 of DNS resolution cache 600 (step 802). More specifically, DNS resolver 500 determines if a stored response in non-scoped portion 702 of DNS resolution cache 600 is for a domain name that matches the requested domain name—which can comprise performing a comparison with each of the entries in non-scoped portion 702 in which a response is cached.

If so, DNS resolver 500 returns the cached response from non-scoped portion 702 of DNS resolution cache 600 to the requesting application (step 804), thereby satisfying the request. The application can then initiate a TCP/IP session using the IP address in the response using techniques known in the art. Note that stored responses in scoped portion 700 of DNS resolution cache 600 are not searched during this operation—only stored non-scoped records from non-scoped portion 702 are used to satisfy non-scoped requests.

If the request cannot be satisfied using a cached response from non-scoped portion 702 in DNS resolution cache 600, DNS resolver 500 records the request (i.e., records sufficient information to match a response to the request). DNS resolver 500 then generates a DNS query that includes the domain name (step 806). Next, DNS resolver 500 forwards the DNS query to operating system 300 along with an indication that the DNS query can be transmitted from any of the available interfaces (step 808). Operating system 300 then processes the DNS query in the network protocol stack and transmits the processed DNS query over any of the available interfaces to corresponding DNS servers.

When a response to the DNS query is subsequently received from a DNS server, operating system 300 processes the response in the network protocol stack and returns the processed response to DNS resolver 500 (step 810). DNS resolver 500 determines the application to which the response is to be returned by comparing information in the response with records of as-yet-unresolved requests and forwards the response to the appropriate requesting application (step 812), thereby satisfying the request. The application can then initiate a TCP/IP session using the IP address in the response using techniques known in the art.

In addition to forwarding the response to the requesting application, DNS resolver 500 caches a copy of the response in non-scoped portion 702 of DNS resolution cache 600 (step 814). More specifically, because the request from the application was non-scoped, DNS resolver 500 caches the response in non-scoped portion 702. DNS resolver 500 can then use the cached response to satisfy subsequent non-scoped IP address requests for the domain name.

### Performing a Scoped DNS IP Address Resolution for a Domain Name

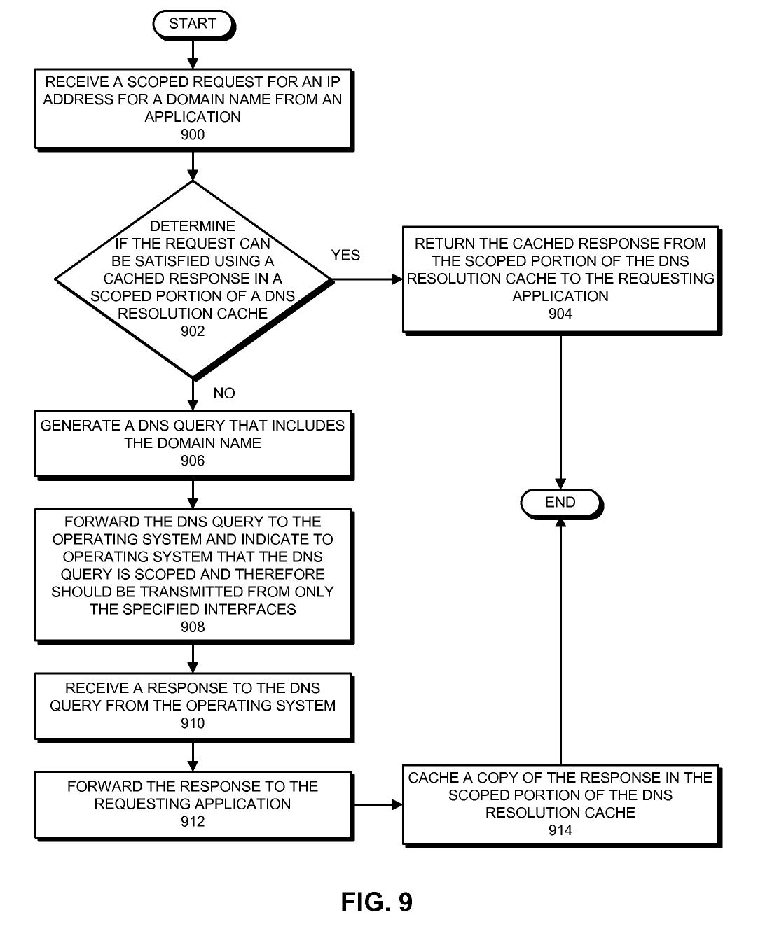

FIG. 9 presents a flowchart illustrating a process for performing a scoped IP address resolution for a domain name in accordance with the described embodiments. The process shown in FIG. 9 starts when DNS resolver 500 receives a scoped request for an IP address for a domain name from an application executing on electronic device 100 (e.g., one of applications 302-306) (step 900). For example, DNS resolver 500 can receive a request that indicates the domain name “mail.service.net.” Because the request is scoped, the request indicates that DNS resolver 500 should cause operating system 300 to transmit a corresponding DNS query only on a specified interface (e.g., interface 400 or interfaces 400 and 402).

DNS resolver 500 then determines if the request can be satisfied using a cached response from scoped portion 700 of DNS resolution cache 600 (step 902). More specifically, DNS resolver 500 determines if a stored response in scoped portion 700 of DNS resolution cache 600 is for a domain name that matches the requested domain name—which can comprise performing a comparison with each of the entries in scoped portion 700 in which a response is cached. If so, DNS resolver 500 returns the cached response from scoped portion 700 of DNS resolution cache 600 to the requesting application (step 904), thereby satisfying the request. The application can then initiate a TCP/IP session using the IP address in the response using techniques known in the art. Note that stored responses in non-scoped portion 702 of DNS resolution cache 600 are not searched during this operation—only stored scoped records from scoped portion 700 are used to satisfy scoped requests.

If the request cannot be satisfied using a cached response from scoped portion 700 in DNS resolution cache 600, DNS resolver 500 records the request (i.e., records sufficient information to match the request to a response). DNS resolver 500 then generates a DNS query that includes the domain name (step 906). Next, DNS resolver 500 forwards the DNS query to the operating system 300 along with an indication that the request is scoped and should therefore only be transmitted from the specified interfaces (step 908). Operating system 300 then processes the DNS query in the network protocol stack and transmits the processed DNS query using the indicated interfaces to corresponding DNS servers.

When a response to the DNS query is subsequently received from a DNS server, operating system 300 processes the response in the network protocol stack and returns the processed response to DNS resolver 500 (step 910). DNS resolver 500 determines the application to which the response is to be returned by comparing information in the response with records of as-yet-unresolved requests and forwards the response to the appropriate requesting application (step 912), thereby satisfying the request. The application can then initiate a TCP/IP session using the IP address in the response using techniques known in the art.

In addition to forwarding the response to the requesting application, DNS resolver 500 caches a copy of the response in scoped portion 700 of DNS resolution cache 600 (step 914). More specifically, because the request from the application was scoped, DNS resolver 500 caches the response in scoped portion 700. As part of caching the response in scoped portion 700, DNS resolver 500 records the interface or interfaces upon which the DNS query was transmitted along with recording the DNS server that responded to the request. DNS resolver 500 can then use the cached response to satisfy subsequent scoped IP address requests for the domain name and for the specified interfaces.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for domain name resolution in an electronic device with a plurality of network interfaces, comprising:
in the electronic device,
receiving a scoped request from an application to determine an IP address for a domain name, wherein the scoped request comprises an indication that a DNS query generated from the scoped request is to transmitted only on network interfaces specified in the scoped request, and wherein a non-scoped request comprises an indication that a DNS query generated from the non-scoped request can be transmitted on any of the network interfaces;
generating a DNS query from the scoped request and transmitting the DNS query only on the network interfaces specified in the scoped request; and
upon receiving a response to the DNS query,
forwarding the response to the application; and
storing a record of the response in a scoped portion of a DNS resolution cache that is used only for storing responses to scoped requests, wherein a non-scoped portion of the DNS resolution cache is used only for storing responses to non-scoped requests.

2. The method of claim 1, further comprising:
receiving a subsequent scoped request to determine an IP address for a domain name from an application; and
checking stored responses in the scoped portion of the DNS resolution cache to determine if a stored response can be used to satisfy the subsequent scoped request;
if so, using the stored response to satisfy the subsequent scoped request;
otherwise, generating a DNS query based on the subsequent scoped request and transmitting the DNS query only on the network interfaces specified in the scoped request.

3. The method of claim 1, further comprising:
receiving a non-scoped request to determine an IP address for a domain name from an application;
generating a DNS query based on the non-scoped request and transmitting the DNS query on any of the network interfaces; and
upon receiving a response to the DNS query,
forwarding the response to the requesting application; and
storing a record of the response in the non-scoped portion of the DNS resolution cache.

4. The method of claim 3, further comprising:
receiving a subsequent non-scoped request to determine an IP address for a domain name from an application; and
checking stored responses in the non-scoped portion of the DNS resolution cache to determine if a stored response can be used to satisfy the subsequent non-scoped request;
if so, using the stored response to satisfy the subsequent non-scoped request;
otherwise, generating a DNS query based on the subsequent non-scoped request and transmitting the DNS query on any of the network interfaces.

5. The method of claim 1, wherein receiving the scoped request comprises:
receiving a call to a function in an application programming interface (API), wherein the call to the function comprises an argument that specifies the network interfaces upon which the DNS query is to be transmitted.

6. The method of claim 1, wherein the method further comprises:
storing a record of the scoped request, wherein the record comprises information to identify the application that made the request and to determine that the request was scoped;
upon receiving the response to the DNS query, using the information in the record of the scoped request to determine the application that sent the request and to determine that the request was scoped; and
performing the forwarding and storing operations based on the determination.

7. The method of claim 1, wherein storing the record of the response in the scoped portion of the DNS resolution cache comprises:
updating an entry in the scoped portion of the DNS resolution cache with information comprising:
the domain name from the response;
the IP address from the response;
the network interface that was used to send the DNS query; and
a DNS server that responded to the request.

8. An apparatus, comprising:
a DNS resolution cache, wherein the DNS resolution cache comprises a memory for caching records of responses to DNS queries;
a scoped portion in the DNS resolution cache, wherein the scoped portion is used for caching records of responses to scoped DNS queries; and
a non-scoped portion in the DNS resolution cache, wherein the non-scoped portion is used for caching records of responses to non-scoped DNS queries.

9. The apparatus of claim 8, wherein the memory in the DNS resolution cache is a contiguous block of memory, and wherein the DNS resolution cache further comprises:
one or more mechanisms configured to indicate the scoped portion and the non-scoped portion.

10. The apparatus of claim 8, wherein the memory in the DNS resolution cache comprises two or more a non-contiguous blocks of memory, and wherein the DNS resolution cache further comprises:
one or more mechanisms configured to indicate the scoped portion and the non-scoped portion.

11. The apparatus of claim 8, wherein the DNS resolution cache further comprises:
one or more adjustment mechanisms configured to dynamically adjust at least one of a size or an arrangement of at least one of the scoped portion, the non-scoped portion, or the DNS resolution cache at runtime based on one or more conditions.

12. The apparatus of claim 8, wherein the DNS resolution cache further comprises:
one or more lookup mechanisms configured to:
compare non-scoped requests with cached records of responses to non-scoped requests to determine if the non-scoped requests can be satisfied from the cached records of responses to non-scoped requests; and
compare scoped requests to cached records of responses to scoped requests to determine if the scoped requests can be satisfied from the cached records of responses to scoped requests; and
a returning mechanism configured to return recorded responses to scoped and non-scoped requests when the scoped and non-scoped requests can be satisfied from corresponding cache records.

13. The apparatus of claim 8, wherein the memory for caching records of responses from DNS queries in the DNS resolution cache comprises a set of entries used to store the records of the responses, each entry comprising information for identifying and satisfying requests for IP addresses based on domain names.

14. The apparatus of claim 13, wherein the information in each entry comprises:
the domain name from a response to DNS query;
the IP address from the response to DNS query;
the interface that was used to send the DNS query; and
the DNS server that sent the response.

15. An electronic device, comprising:
a processing subsystem, wherein the processing subsystem performs computational operations for the electronic device;
a networking subsystem coupled to the processing subsystem, wherein the networking subsystem comprises a plurality of network interfaces; and
a DNS resolution cache coupled to the networking subsystem, wherein the DNS resolution cache comprises:
a scoped portion that is used to cache responses for scoped requests to determine an IP address for a domain name, wherein a scoped request comprises an indication that a DNS query generated from the scoped request is to transmitted only on network interfaces specified in the scoped request; and
a non-scoped portion that is used to cache responses from non-scoped requests to determine an IP address for a domain name, wherein a non-scoped request comprises an indication that a DNS query generated from the non-scoped request is to transmitted on any of the network interfaces.

16. The electronic device of claim 15, further comprising:
a memory subsystem coupled to the network interfaces, wherein the memory subsystem includes one or more computer-readable storage mediums, wherein the DNS resolution cache is implemented in at least one of the computer-readable storage mediums.

17. A computer-readable storage medium storing computer program instructions that, when executed by a processing subsystem, cause the processing subsystem to perform a method for domain name resolution in an electronic device with a plurality of network interfaces, the method comprising:
receiving a scoped request from an application to determine an IP address for a domain name, wherein the scoped request comprises an indication that a DNS query generated from the scoped request is to transmitted only on network interfaces specified in the scoped request, and wherein a non-scoped request comprises an indication that a DNS query generated from the non-scoped request can be transmitted on any of the network interfaces;
generating a DNS query from the scoped request and transmitting the DNS query only on the network interfaces specified in the scoped request; and
upon receiving a response to the DNS query,
forwarding the response to the application; and
storing a record of the response in a scoped portion of a DNS resolution cache that is used only for storing responses to scoped requests, wherein a non-scoped portion of the DNS resolution cache is used only for storing responses to non-scoped requests.

18. The computer-readable storage medium of claim 17, wherein the method further comprises:
receiving a subsequent scoped request to determine an IP address for a domain name from an application; and
checking stored responses in the scoped portion of the DNS resolution cache to determine if a stored response can be used to satisfy the subsequent scoped request;
if so, using the stored response to satisfy the subsequent scoped request;
otherwise, generating a DNS query based on the subsequent scoped request and transmitting the DNS query only on the network interfaces specified in the scoped request.

19. The computer-readable storage medium of claim 17, wherein the method further comprises:
receiving a non-scoped request to determine an IP address for a domain name from an application;
generating a DNS query based on the non-scoped request and transmitting the DNS query on any of the network interfaces; and
upon receiving a response to the DNS query,
forwarding the response to the requesting application; and
storing a record of the response in the non-scoped portion of the DNS resolution cache.

20. The computer-readable storage medium of claim 19, wherein the method further comprises:
receiving a subsequent non-scoped request to determine an IP address for a domain name from an application; and
checking stored responses in the non-scoped portion of the DNS resolution cache to determine if a stored response can be used to satisfy the subsequent non-scoped request;
if so, using the stored response to satisfy the subsequent non-scoped request;
otherwise, generating a DNS query based on the subsequent non-scoped request and transmitting the DNS query on any of the network interfaces.

21. The computer-readable storage medium of claim 17, wherein receiving the scoped request comprises:
receiving a call to a function in an application programming interface (API), wherein the call to the function comprises an argument that specifies the network interfaces upon which the DNS query is to be transmitted.

22. The computer-readable storage medium of claim 17, wherein the method further comprises:
storing a record of the scoped request, wherein the record comprises information to identify the application that made the request and to determine that the request was scoped;
upon receiving the response to the DNS query, using the information in the record of the scoped request to determine the application that sent the request and to determine that the request was scoped; and
performing the forwarding and storing operations based on the determination.

23. The computer-readable storage medium of claim 17, wherein storing the record of the response in the scoped portion of the DNS resolution cache comprises:
updating an entry in the scoped portion of the DNS resolution cache with information comprising:
the domain name from the response;
the IP address from the response;
the network interface that was used to send the DNS query; and
a DNS server that responded to the request.
